(19) United States
(12) Patent Application Publication
(10) Pub. No.: US 2011/0056387 A1
(43) Pub. Date: Mar. 10, 2011

(54) ROLLER GRILL SEPARATING DEVICE

(76) Inventor: Michael M. KURMLAVAGE, Lansdowne, PA (US)

(21) Appl. No.: 12/554,645

(22) Filed: Sep. 4, 2009

(51) Int. Cl. A47J 36/00

(52) U.S. Cl. 99/352

(57) ABSTRACT

A roller grill separating device having a pair of support brackets, a pair of crossover bars, and one or more separator bar. The separating device sits over a roller grill and can be spaced therefrom. A plurality of the separator bars can be used to create separate sections on the grill to separate uncooked products from cooked products or to separate one flavor from another. The device can include a sign clip that is used for identifying and marketing different types of food products. The pair of support brackets can be replaced by a plurality of clips that fasten onto rollers or by support angled members that rest on the housing of the roller grill. The device is inexpensive to make and is sanitary.

### BACKGROUND OF THE INVENTION

1. Field of the Invention

This invention relates to a roller grill separating device used in conjunction with a roller grill, which assists grill operators to separate uncooked products from cooked products and provide separate cooking areas for different products.

2. Discussion of the Related Art

In this era of fast food, individuals are increasingly dependent on quick service restaurants and convenience stores for a quick meal. Beginning in the 1960s and increasing in popularity ever since, the roller grill became an efficient way to cook and store hot dogs and other products to be made readily available to consumers without being labor intensive. With the advent of roller grills, these products could be prepared without the necessity of the store clerk flipping or rolling the grilled food by hand throughout the day. The development of the gas station/convenience store made this type of food even more widely available and popular.

With more opportunities to sell more products in these numerous establishments, the industry began offering additional hot dog types of products such as sausage, a quarter pound hot dog, spicy, mild, kielbasa, alternative meat hot dogs such as turkey, beef or soy, and others. All of these foods were still best prepared using the roller grill. Indeed, presently roller grills are still the leading hot dog cooker of choice for national convenience store chains, vending operations and cafeterias. These roller grills can be used on the front serving counter where customers serve themselves or on a back counter where a store employee takes an order from a customer and assembles and serves the food product such as a hot dog.

In a roller grill that can cook many food products at one time, it is not always the case that one type of product is placed on the grill and removed from the grill all at once.

Rather, the number of the products on the grill gradually decreases based on sales, and a grill operator accordingly keeps adding uncooked food on the grill. Therefore, cooked products and uncooked products are on the grill at the same time, and it is possible that uncooked products might contaminate cooked products. Without an effective grill separating device, it is hard for a grill operator to organize and manage the grill. It is also hard to identify which part is cooked and which part is uncooked, and which part is one type of product and which part is another. Also, hot dog items can move or “walk” from side to side and away from their respective sign identifier thus confusing customers and operators and making the grill look unorganized.

Various devices have been proposed for overcoming these challenges. For example, in U.S. patent application Ser. No. 11/257,424, the contents of which are hereby incorporated by reference, sections are provided on a roller grill. This application illustrates a roller grill separating device having clips, separating bars, and crossover bars, which together create rectangular separated areas on a roller grill. The size of each area can be easily adjusted by moving the clips, separator bars, and crossover bars relative to each other.

A roller grill having a section divider ensemble is disclosed in U.S. Pat. Nos. 7,367,261 and 7,334,517. U.S. Pat. No. 7,367,261 provides a roller grill with a built-in fixed divider ensemble shaped to be positioned above the rollers for sectioning the rollers into two cooking areas. U.S. Pat. No. 7,334,517 further provides a roller grill with a section divider ensemble comprising front and back divider mounting braces, each having a series of slots or openings to accommodate divider bars. This arrangement makes it possible to vary the number and sizes of the cooking areas. In this divider ensemble device, use and vibrations can cause the spacing between the front and rear braces to become larger and then the dividers can fall onto the roller grill cooking surfaces.

If an operator has a roller grill and wants to have divided cooking areas on their roller grill, typically, they must purchase a new roller grill with the divider feature installed. This new roller grill then replaces the existing roller grill and this can cause a significant expenditure.

There is currently no device that effectively separates cooking areas on a grill without taking up much cooking space and at the same time displays marketing information and the types of food products for consumers and operators.

### SUMMARY OF THE INVENTION

The present invention provides a roller grill separating device that can be used on an existing roller grill of any size, thus eliminating the need to purchase a brand new roller grill with a divider ensemble.

The present invention provides a roller grill separating device that keeps grilled products in place and keeps uncooked products separated from cooked products on a grill so as to reduce food borne contamination and to maintain grill neatness at the same time. The separating device is designed to sit over a roller grill of any size. Since this separating device rests on the side and above the roller grill, it takes up very little cooking space on the grill, and is sturdy enough to avoid being knocked over. Moreover, the device is easy to manufacture and assemble.

The roller grill separating device includes a pair of support brackets and a pair of crossover bars to form a frame that is disposed over the roller grill. The device also includes a plurality of separator bars to easily divide a roller grill into separate sections and can be positioned in an infinite number of positions. The device can have a varied number of separator bars depending on how many separate sections a grill operator would like to have. The device can also have a sign clip to secure information panels that display point-of-sale items such as the price, specials, promotions, ingredients, new flavors, etc.

In another embodiment, at least four clips clip onto the grill rollers and are spaced apart along the rollers. The clips are joined by a plurality of separator bars and crossover bars that are disposed at right angles to each other.

In another embodiment, at least four support angled members, which can be disposed at the four corners of the separating device are joined by a plurality of separator bars and crossover bars that are disposed at right angles to each other.

The above and other objects and advantages are achieved with a roller grill separating device comprising a pair of support brackets being disposed on opposite sides of a housing of a roller grill, a pair of crossover bars being disposed between the support brackets, and at least one separator bar being disposed parallel to the support brackets.

The above and other objects and advantages are also achieved with the roller grill separating device described above and a sign clip that can display point-of-sale items such as flavor and price.

Moreover, the above and other objects and advantages are achieved with another roller grill separating device, wherein a plurality of clips are spaced apart and joined by separator bars and crossover bars.

The device is designed to work on any roller grill. The separating device is designed to safely segment a roller grill so that uncooked food does not contaminate cooked food and flavors of each food do not blend. It is easy to assemble the separating device with one or more separator bars to create two or more separate sections on the grill. The separating device also neatly organizes a grill and makes the appearance of the roller grill look neat and orderly.

Other objects, features and advantages of the invention will be apparent from the following detailed description taken in conjunction with the accompanying drawings wherein preferred embodiments of the invention have been selected for exemplification and from the individual features and relationships of the respective appended claims.

### BRIEF DESCRIPTION OF THE DRAWINGS

The above and other objects and features of the present invention will be clearly understood from the following description with respect to the preferred embodiments thereof when considered in conjunction with the accompanying drawings, wherein the same reference numerals have been used to denote the same or similar parts or elements, and in which:

FIGS. 1A-1D are perspective views of a roller grill separating device according to a first embodiment of the present invention; and FIG. 1E is a perspective view of a roller grill separating device according to the first embodiment with a different angled support member;

FIG. 2 is a perspective view of the roller grill separating device disposed on a roller grill according to the first embodiment shown in FIG. 1;

FIG. 3A is a perspective view of a support bracket;

FIG. 3B is a perspective view of another type of support bracket;

FIG. 4A is a perspective view of the roller grill separating device having clips and signs according to the first embodiment shown in FIG. 1;

FIG. 4B is a perspective view of the roller grill separating device having clips and signs including a flavor banner disposed in clips according to the first embodiment shown in FIG. 1; and

FIG. 4C is a perspective view of the roller grill separating device having additional clips and different sign holders with slides according to the first embodiment;

FIG. 5 is a perspective view of a roller grill separating device according to a second embodiment of the present invention;

FIG. 6 is a perspective view of a roller grill separating device according to a third embodiment of the present invention;

FIG. 7 is a perspective view of a roller grill separating device according to a fourth embodiment of the present invention;

FIG. 8 is a perspective view of a roller grill separating device according to a fifth embodiment of the present invention; and

FIGS. 9A-9C are perspective views of three different support angled members according to the fifth embodiment shown in FIG. 8, where different portions of the support angled members have been removed to be allow the support angled members to fit on different types of roller grills.

FIG. 10 is a perspective view of a roller grill separating device according to a sixth embodiment of the present invention;

FIG. 11 is a perspective view of a roller grill separating device according to a seventh embodiment of the present invention;

FIG. 12 is a perspective view of a roller grill separating device according to an eighth embodiment of the present invention;

FIG. 13 is a perspective view of the roller grill separating device attached to a cover disposed on a roller grill according to the eighth embodiment shown FIG. 12;

FIG. 14 is a perspective view of a roller grill separating device having a support base member according to a ninth embodiment of the present invention;

FIG. 15A is a perspective view of a roller grill separating device according to a tenth embodiment of the present invention;

FIG. 15B is a perspective view of similar to FIG. 15A including two different types of clips having sign members disposed in the clips;

FIG. 16 is a perspective view of a roller grill separating device including a hanging device according to an eleventh embodiment of the present invention that is disposed on a roller grill;

### DETAILED DESCRIPTION OF THE PREFERRED EMBODIMENTS

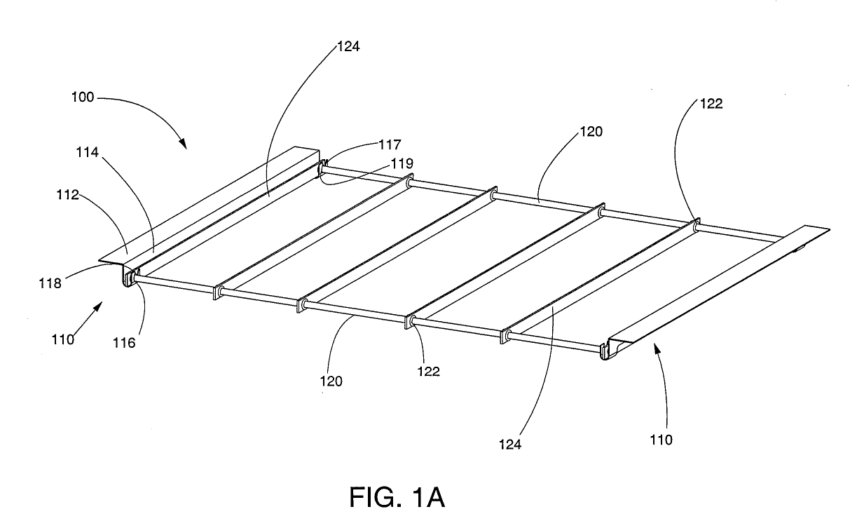

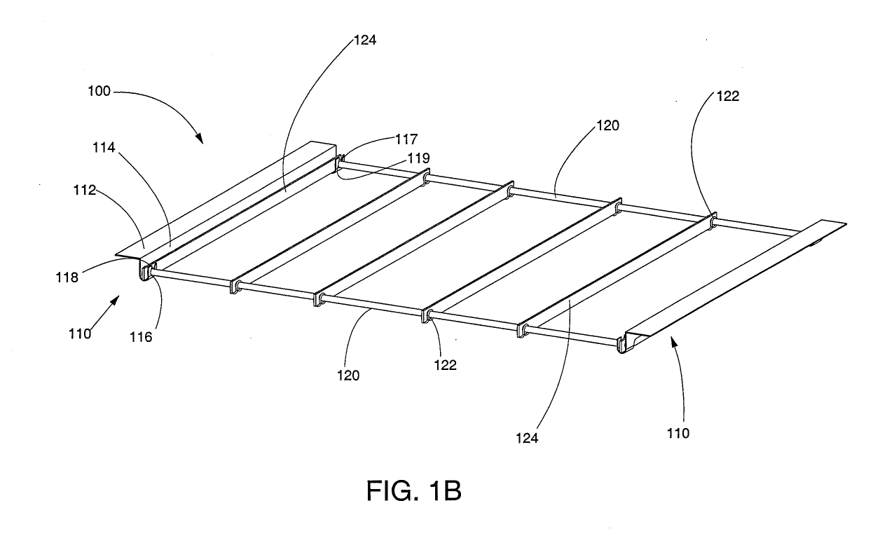

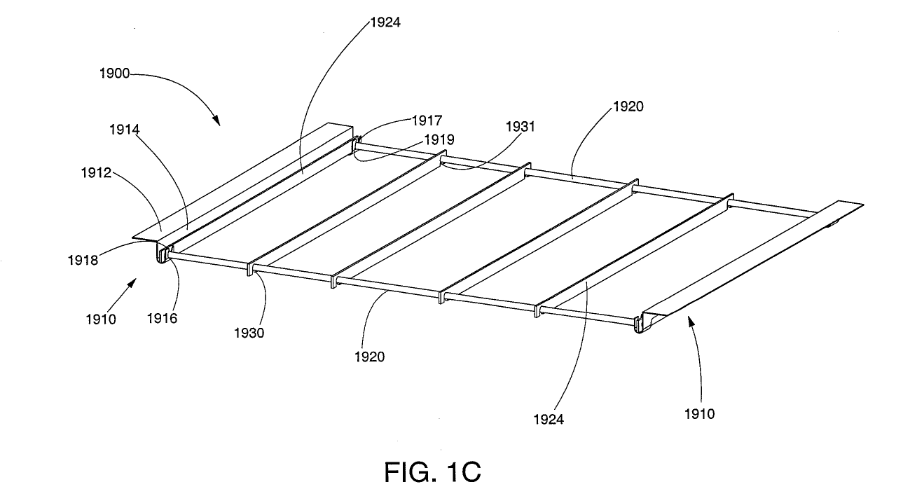

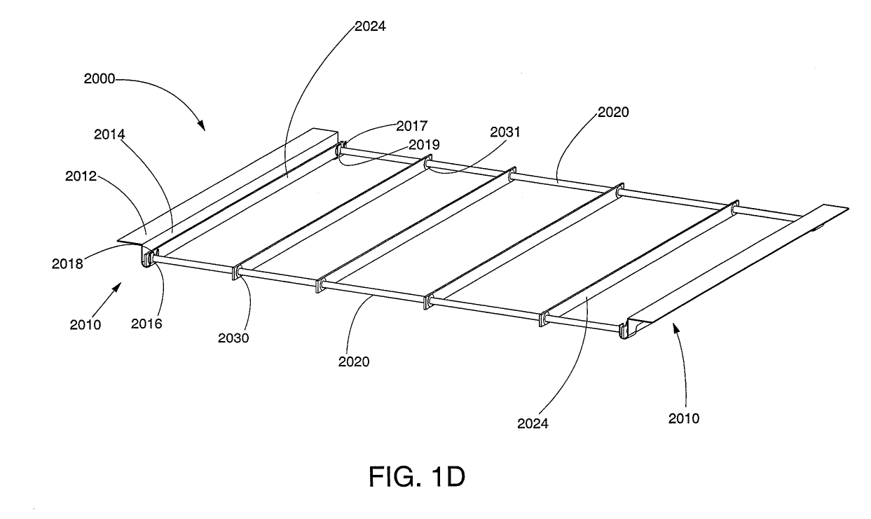

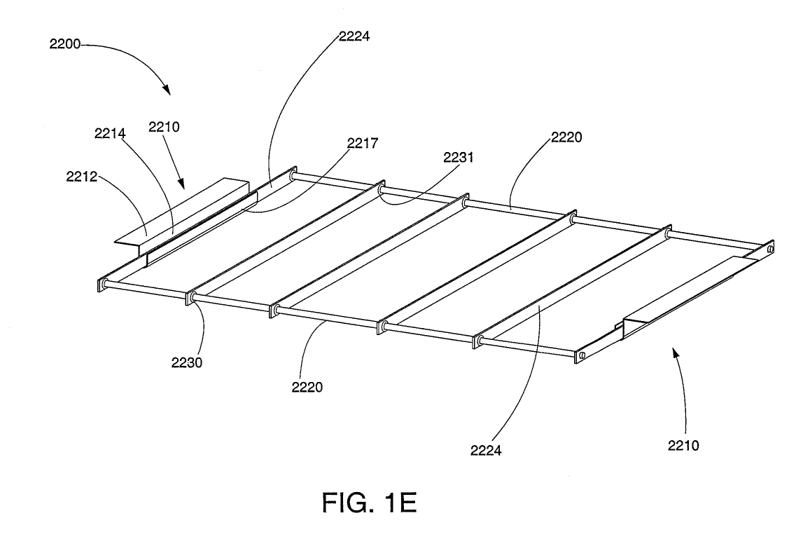

FIG. 1 illustrates a roller grill separating device 100 comprising two support brackets 110, two crossover bars 120, and a plurality of separator bars 124. The support bracket 110 is at each of the right and left ends of the device 100. There is the crossover bar 120 at each of the front and rear sides of the device 100.

The separator bars 124 are disposed parallel to the support brackets 110 and are perpendicular to the crossover bars 120. The support bracket 110 further comprises a top section 112, a side section 114, and a lower section 116 at a proximate side and another lower section 117 at a distant side. The lower sections 116 and 117 bend upward and create a space between the side section 114 and the lower sections 116 and 117 where a separator bar 124 can rest. Each of the lower sections 116 and 117 also has a notch 118, 119, respectively, where an end of the crossover bar 120 is positioned.

The number of the separator bars 124 can vary according to the preference of the user on how many sections they would like to make. The separator bar 124 adjacent to the support bracket 110 can be omitted, thus it is possible to use one separator bar 124. The crossover bar 120 goes through a hole of the separator bar 124. A set of two o-rings 122 around the hole at each side of the separator bar 124 keeps the separator bar 124 from sliding across the crossover bar 120. Instead of using two o-rings at each side of the separator bar 124, one large o-ring 122 can be used to loop around the hole at each side of the separator bar 124 as shown in FIG. 1B.

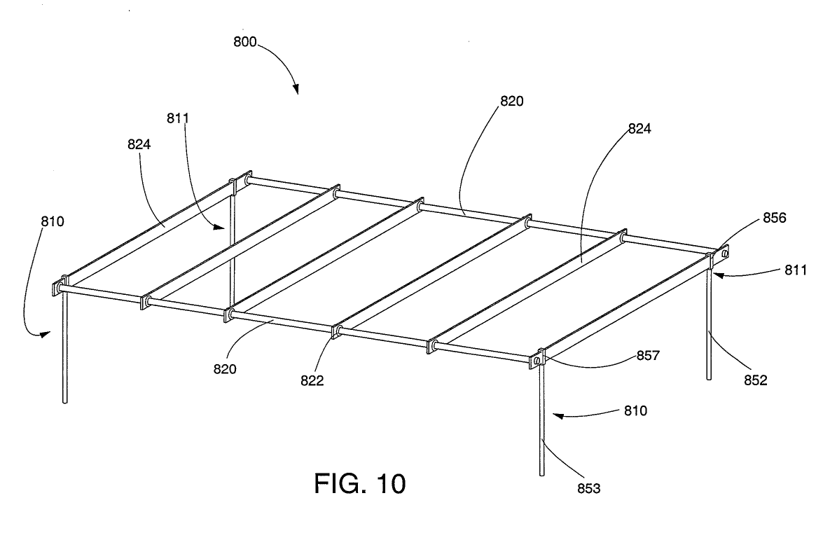

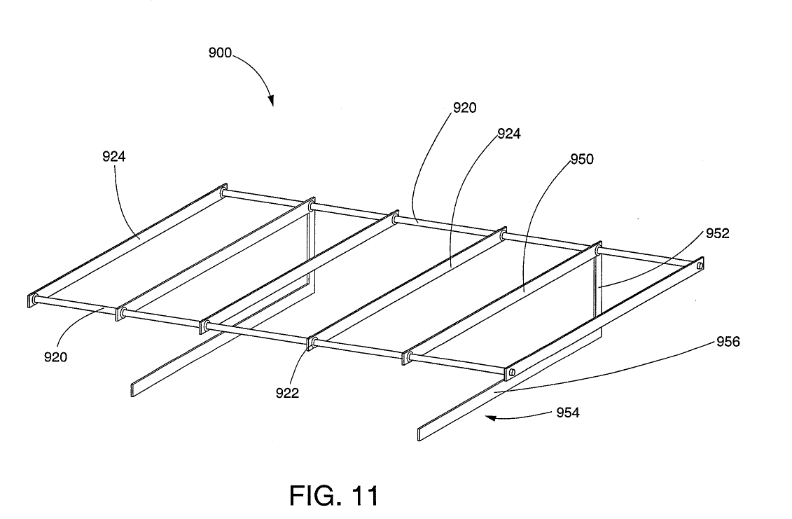

The separator bar 124 can have U-shaped openings 1930 and 1931 at each end instead of the circular opening as shown in FIG. 10 by separator bar 1924. In this figure, the same elements shown in FIGS. 1A and 1B have been renumbered so that the elements are labeled by reference numerals that start with 19 instead of starting with 1.

Moreover, o-rings 2030 and 2031 can be replaced with a rubber grommet as shown in FIG. 1D or any type of clip that would prevent the dividers from moving from the desired setting. In this figure, the same elements shown in FIGS. 1A and 1B have been renumbered so that the elements are labeled by reference numerals that start with 20 instead of starting with 1.

As shown in FIG. 1E, the support bracket 2210 comprises a top section 2212, a side section 2214 which is connected to a lower section 2217 at a distant side. The bottom portion of the support bracket 2210 can be a curved or straight section between side section 2214 and lower section 2217 that can support the separator bar 2224. In this figure, the same elements shown in FIGS. 1A and 1B have been renumbered so that the elements are labeled by reference numerals that start with 22 instead of starting with 1.

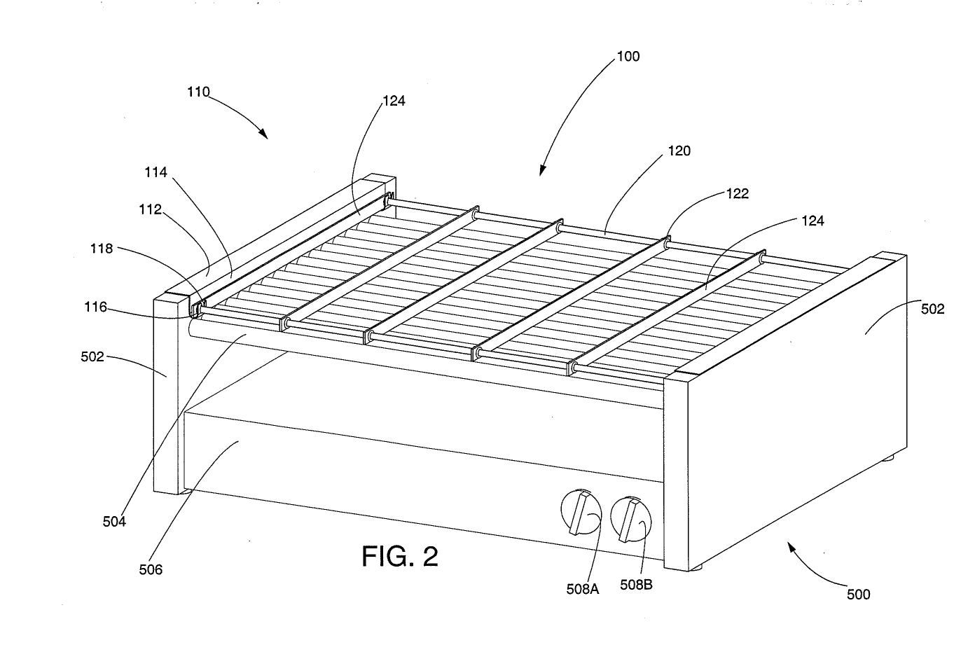

FIG. 2 illustrates the roller grill separating device 100 disposed on a roller grill 500. The roller grill 500 comprises a housing 502, a plurality of rollers 504, and a lower section 506. A front part of the lower section 506 includes knobs 508A and 508B.

The top section 112 of each of the support brackets 110 rests on a respective side of the housing 502 of the roller grill 500. As shown, the roller grill separating device 100 is disposed over the roller grill 500 and thus does not scratch the rollers 504.

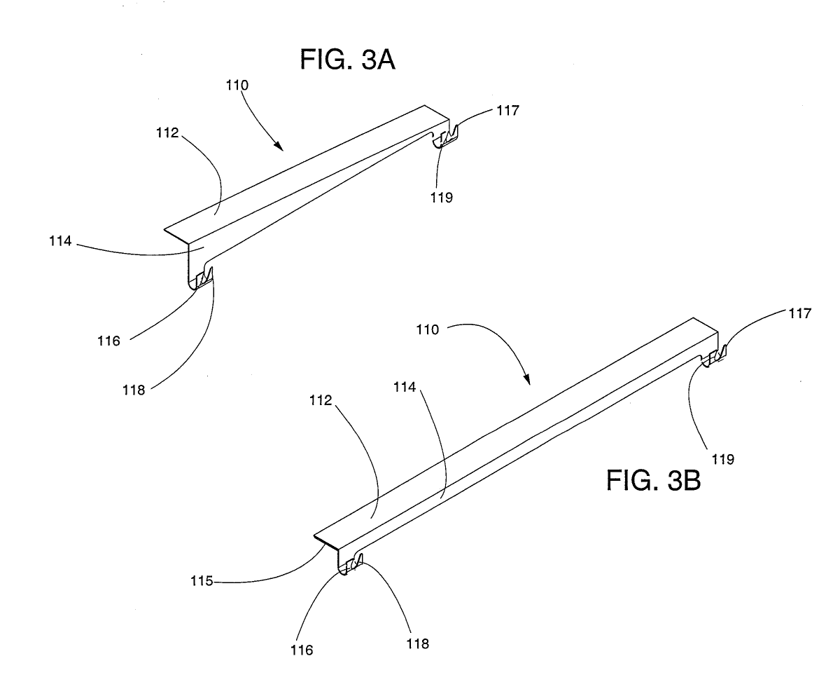

FIGS. 3A and 3B show two versions of the support bracket 110. A lower side of the side section 114 can be angled as shown in FIG. 3A or can be straight as shown in FIG. 3B. The support bracket of FIG. 3A is used for a slanted roller grill, and the support bracket of FIG. 3B is used for a flat or slanted roller grill. The length of the support bracket 110 can also vary according to the size of a grill. Under the top section 112, an optional magnetic strip or bar 115 can be disposed which will assist in holding the support bracket 110 on the side of the roller grill. This magnetic strip section can be adapted to also be located on the side section 114 and/or even be shorted to be adaptable to any length of support bracket disclosed.

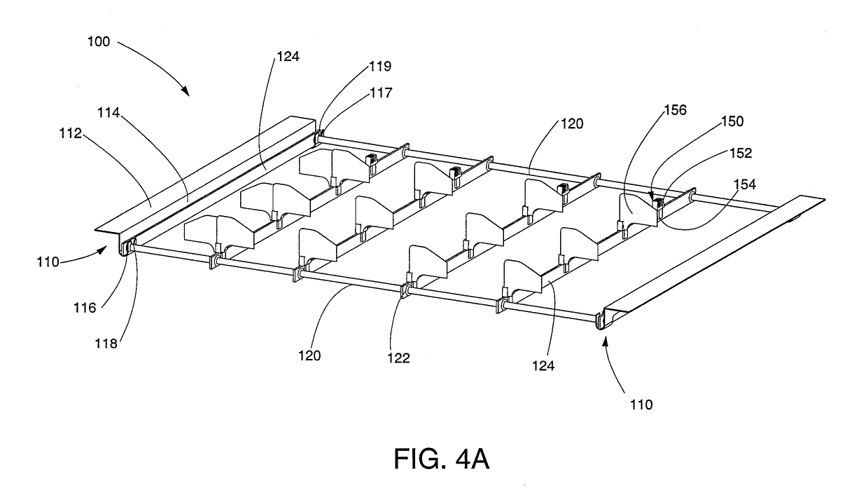

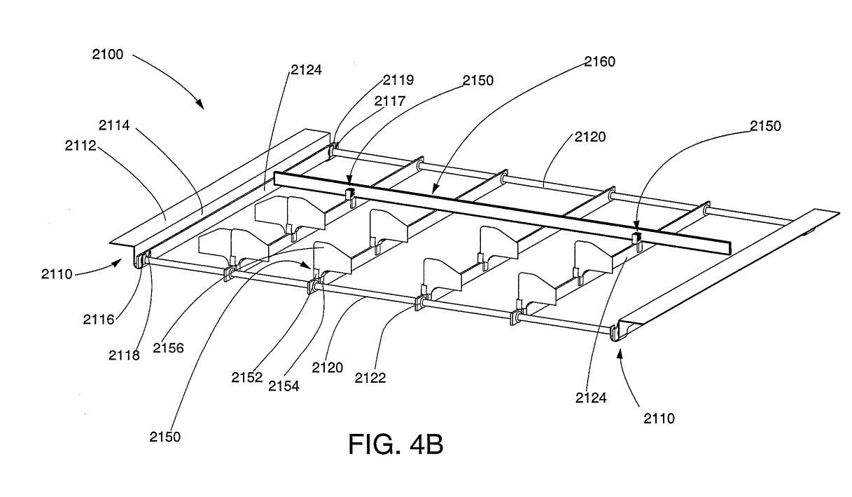

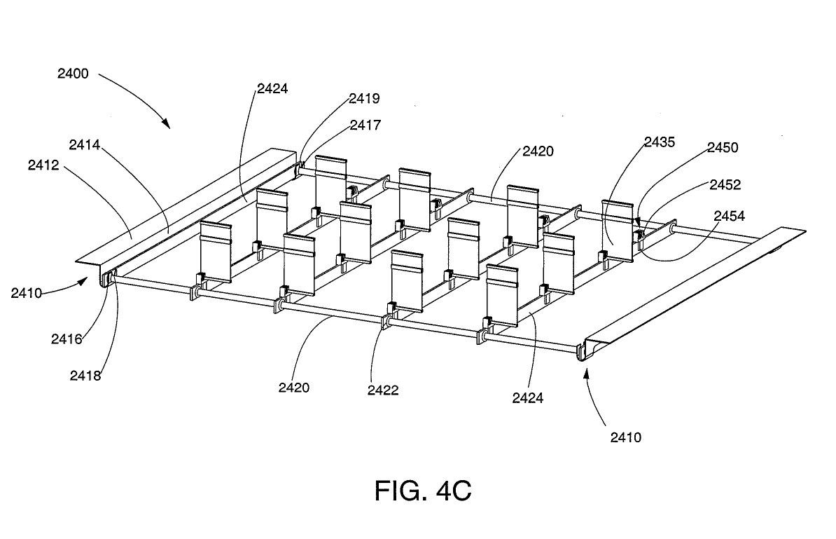

FIG. 4A discloses a roller grill separating device 100 accompanying a plurality of clips 150 and signs 156. The clip 150 comprises an upper section 152 and a lower section 154. Details of the clip 150 are shown in U.S. Design Pat. Nos. D586,404 and D586,405, the contents of which are incorporated hereinto by reference. The signs 156 can be inserted in the upper section 152 of the clip 150. Each of the signs 156 can show many different things, such as flavor, price, and readiness of the food (e.g., “ready” or “not ready”).

FIG. 4B discloses a variation on the roller grill separating device 100 shown in FIG. 4A. FIG. 4B discloses a roller grill separating device 2100 accompanying a plurality of clips 2150 and signs 2156. The signs 2156 can be inserted in the upper section of the clip 2150. Also, a flavor banner 2160 can be inserted in the upper section of at least one clip 2150. The flavor banner 1260 can further divide the roller grill into additional sections. The flavor banners 2160 can also include advertisements or even messages to customers, such as whether the food is ready or still cooking as well as flavors and prices. In this figure, the same elements shown in FIG. 4A have been renumbered so that the elements are labeled by reference numerals that start with 21 instead of starting with 1.

FIG. 4C discloses a roller grill separating device 2400 where the flavor flags 156 in FIG. 4A have been replaced by a molded plastic sign holder with slides 2435 that can be inserted into a clip 2450. In this figure, the same elements shown in FIG. 4A have been renumbered so that the elements are labeled by reference numerals that start with 24 instead of starting with 1.

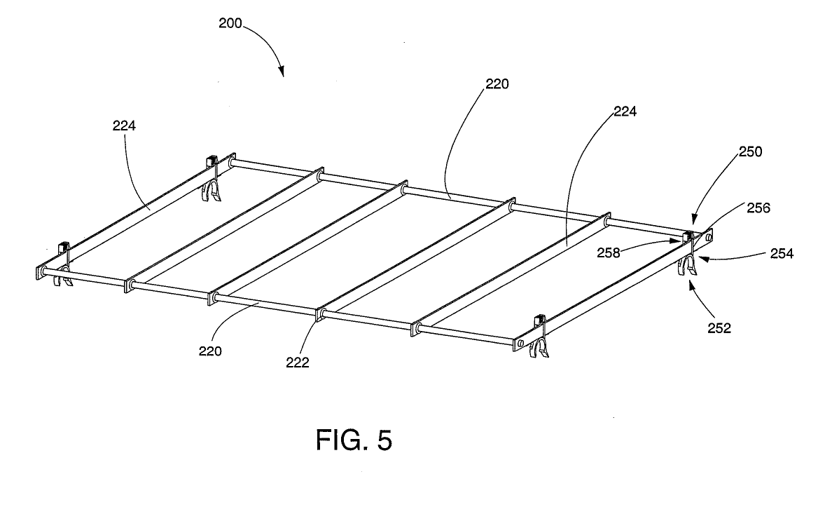

FIG. 5 exhibits another embodiment according to the invention of another roller grill separating device 200. A main difference from the first embodiment depicted in FIG. 1 is the use of clips in place of the support brackets 110. Details of the clip 250 are shown in U.S. patent application Ser. No. 11/257,424, discussed above. The roller grill separating device 200 can comprise four clips 250, two crossover bars 220, and a plurality of separator bars 224 with o-rings 222.

The clip 250 comprises an upper section 258, a center section 254, and a lower section 252. The center section 254 has a built-in separator bar accommodation slot 256. The upper section 258 comprises a plurality of clips to hold a sign. The lower section 252 of the clip 250 clips onto a roller. The clip 250 is preferably made of heat resistant plastic and can also be made of metal, glass, ceramics and other similar materials.

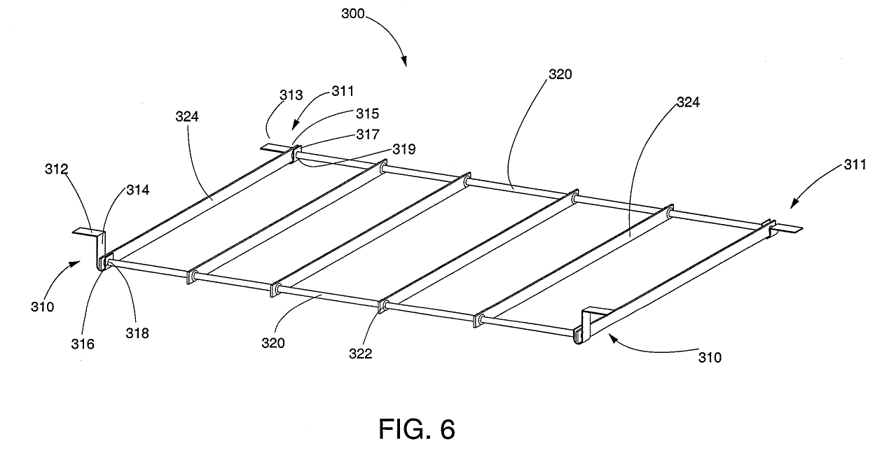

FIG. 6 exemplifies yet another embodiment of another roller grill separating device 300. The use of support angled members in place of the support bracket 110 is a main difference from the first embodiment depicted in FIG. 1. The roller grill separating device 300 comprises two proximate support angled members 310, two distant support angled members 311, two crossover bars 320, and a plurality of separator bars 324 with o-rings 322.

Each of the proximate support angled members 310 and 311 comprise a top section 312, a side section 314, and a lower section 316. The lower section 316 bends upwardly and creates a space between the side section 314 and the lower section 316 where the separator bar 324 can rest. The lower section 316 also has a circular opening 318 through which an end of the crossover bar 320 can extend.

Each of the distant support angled members 311 comprises a top section 313, a side section 315, and a lower section 317. The lower section 317 bends upward and creates a space between the side section 315 and the lower section 317 where the separator bar 324 can rest. The lower section 317 also has a circular opening 319 through which an end of the crossover bar 320 can extend.

In this illustration, the side section 314 of the proximate support angled members 310 is longer than the side section 315 of the distant support angled members 311 in order to fit on a selected slanted roller grills. For a flat roller grill, the height of the side sections 314 and 315 can be the same.

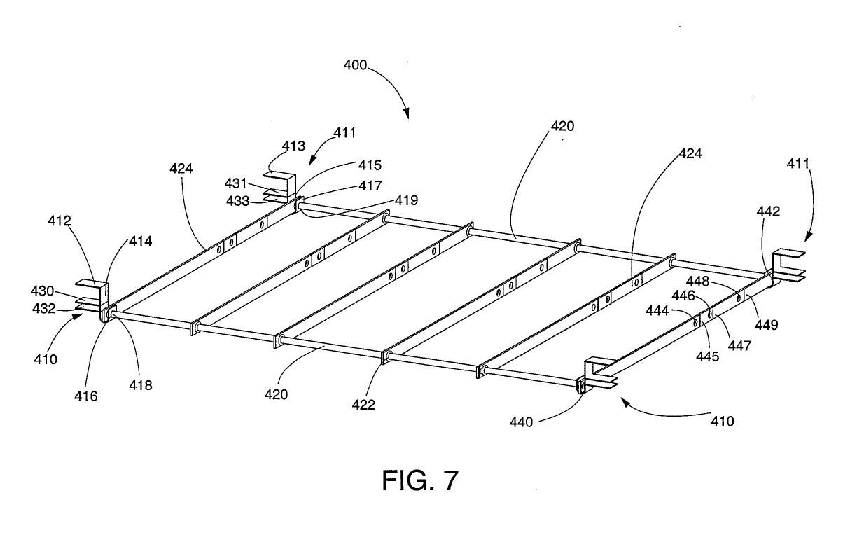

FIG. 7 shows yet another embodiment of another roller grill separating device 400. The use of multi-tabbed support angled members and separator bars with a plurality of cut lines and holes is a difference from the embodiment depicted in FIG. 6. The roller grill separating device 400 comprises two proximate support angled members 410, two distant support angled members 411, two crossover bars 420, and a plurality of separator bars 424 with o-rings 422.

Each of the proximate support angled members 410 comprises a top section 412, a side section 414, and a lower section 416. The lower section 416 also has a circular opening 418 through which an end of the crossover bar 420 can extend. The side section 414 includes a first tab 430 and a second tab 432 that extend from the side section 414 in parallel to the top section 412. The support angled members can be made of plastic or metal. The first tab 430 and the second tab 432 are molded into the side section 414. A customer can snap off any two of the top section 412, the first tab 430 and the second tab 432 and rest the remaining tab (or the top section 412) over a housing according to the size of a roller grill. In that way, one type of the support angled member can fit grills of many different sizes.

Each of the distant support angled members 411 comprises a top section 413, a side section 415, and a lower section 417. The lower section 417 also has a circular opening 419 through which an end of the crossover bar 420 can extend. The side section 415 includes a first tab 431 and a second tab 433 that extend from the side section 415 in parallel to the top section 413. The first tab 431 and the second tab 433 are molded into the side section 415. A customer can snap off any two of the top section 413, the first tab 431 and the second tab 433 and rest the remaining tab (or the top section 413) over a housing according to the size of the roller grill.

As shown in FIG. 7, the separator bar 424 may have a total of five holes, including a proximate hole 440, a distant hole 442, and three holes 444, 446, and 448 in the middle. There are also cut lines 445, 447, and 449 in close proximity of the three holes 444, 446, and 448. The separator bars can be made of plastic or metal. A customer can snap off portions at any one of the cut lines 445, 447, and 449 and insert the crossover bar 420 into the hole next to the chosen cut line according to the dimensions of the roller grill. In that way, one type of the separator bar that can fit many different sizes of roller grills.

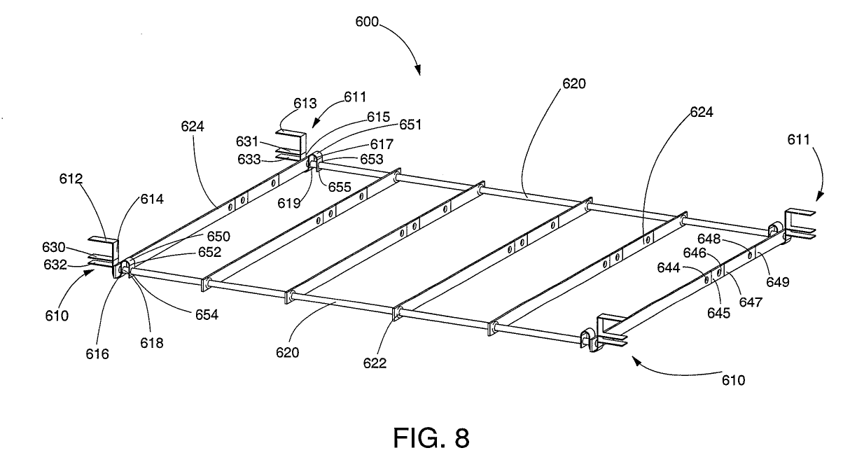

FIG. 8 demonstrates yet another embodiment of another roller grill separating device 600. The use of support angled members with a serpentine strap is one difference from the embodiment depicted in FIG. 7. The roller grill separating device 600 comprises two proximate support angled members 610, two distant support angled members 611, two crossover bars 620, and a plurality of separator bars 624 with o-rings 622.

Each of the proximate support angled members 610 comprises a top section 612, a side section 614 with a first tab 630 and a second tab 632, a lower section 616, an arched section 650 and a strap section 652. The strap section 652 also has a hole 654. Thus, the crossover bar 620 can extend through the hole 654 of the strap section 652 and a hole 618 of the lower section 616. In this way, the support angled member 610 does not fall during placement of the device 600, and the device 600 gets additional stability.

Each of the distant support angled members 611 comprises a top section 613, a side section 615 with a first tab 631 and a second tab 633, a lower section 617, an arched section 651 and a strap section 653. The strap section 653 also has a hole 655. These elements operate in a similar manner as the proximate support angled members described above. In FIG. 8, the same elements shown in FIG. 7 have been renumbered so that the elements are labeled by reference numerals that start with 6 instead of starting with 4.

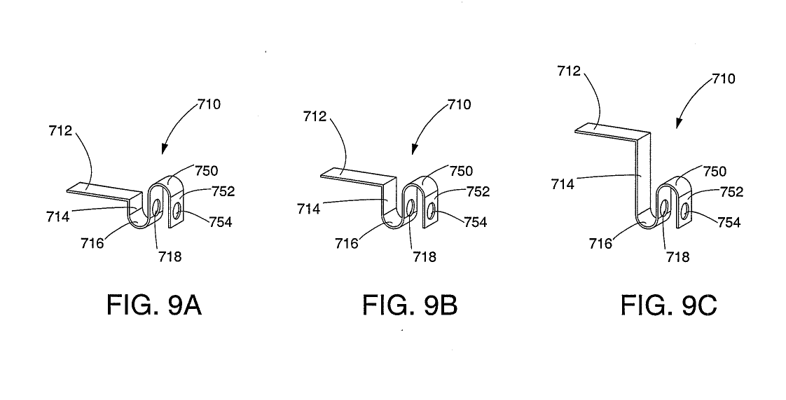

FIGS. 9A-9B show three versions of the support angled members 710. These support angled members 710 are preferably made of metal. A user can choose either one of the three versions based on the depth of the roller grill.

Each of the support angled members 710 comprises a top section 712, a side section 714, a lower section 716, an arched section 750, and a strap section 752. The lower section 716 includes a hole 718, and the strap section 752 also has a hole 754. Preferably the hole 718 and the hole 754 are slightly offset so as to give a slight gripping effect on a crossover bar when the bar is inserted through the two holes.

FIG. 10 demonstrates yet another embodiment of another roller grill separating device 800. The roller grill separating device 800 comprises two proximate support leg members 810, two distant support leg members 811, two crossover bars 820, and a plurality of separator bars 824. The proximate support leg member 810 comprises a leg portion 853 and a frame portion 857. An end of the separator bar 824 is inserted into the frame portion 857. The distant support leg member 811 comprises a leg portion 852 and a frame portion 856. A set of two o-rings 822 around the hole at each side of the separator bar 824 keeps the separator bar 824 from sliding across the crossover bar 820.

FIG. 11 demonstrates yet another embodiment of another roller grill separating device 900. The roller grill separating device 900 comprises two proximate support leg members 954, two crossover bars 920, and a plurality of separator bars 924. Support leg members 954 have the upper structure 950 that acts like a divider, a stem 952, and lower foot 956. A set of two o-rings 922 around the hole at each side of the separator bar 924 and the upper structure 950 keeps the separator bar 924 from sliding across the crossover bar 920. The support leg members 954 could also be located such that they were disposed on the extreme left and right sides of the device or even located in the middle.

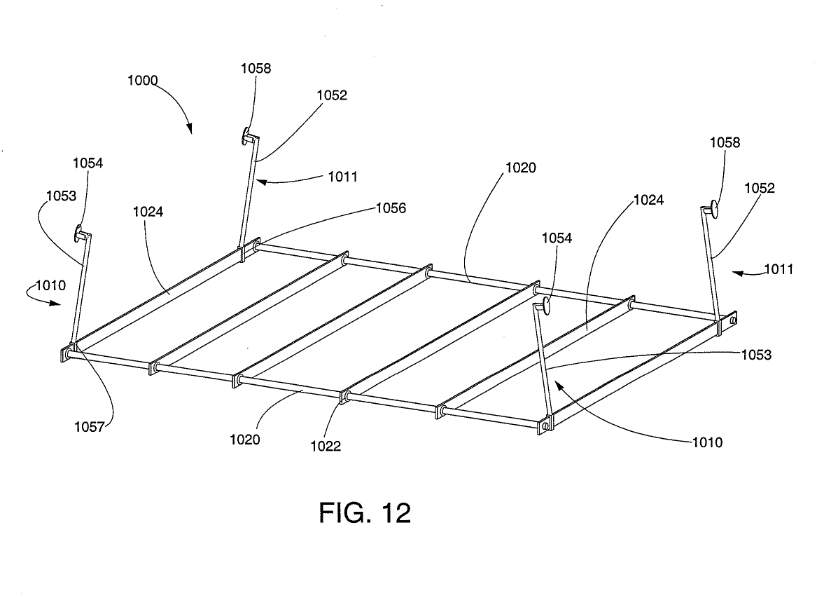

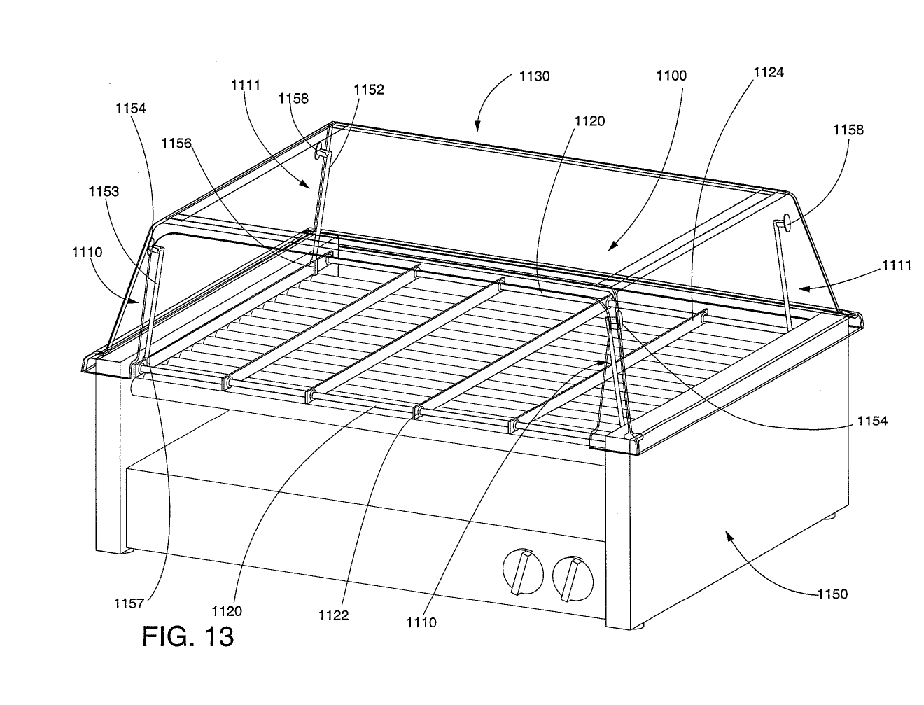

FIG. 12 demonstrates yet another embodiment of another roller grill separating device 1000. The roller grill separating device 1000 comprises two proximate support hanger members 1010, two distant support hanger members 1011, two crossover bars 1020, a plurality of separator bars 1024 and o-rings 1022. The proximate support hanger member 1010 comprises a suction portion 1054, a leg portion 1053, and a frame portion 1057. An end of the separator bar 1024 is inserted into the frame portion 1057. The distant support hanger member 1011 comprises a suction portion 1058, a leg portion 1052, and a frame portion 1056. An end of the separator bar 1024 is inserted into the frame portion 1056. The distant hanger member 1011 can also include an adhesive or some other fastening method instead of a suction portion.

FIG. 13 illustrates the roller grill separating device 1100 disposed on a roller grill 1150. In this figure, the same elements shown in FIG. 12 have been renumbered to start with 11 instead of starting with 10. The roller grill separating device 1100 hangs from a cover 1130 with the suction portions 1154 and 1158 attached to the an interior of the cover 1130.

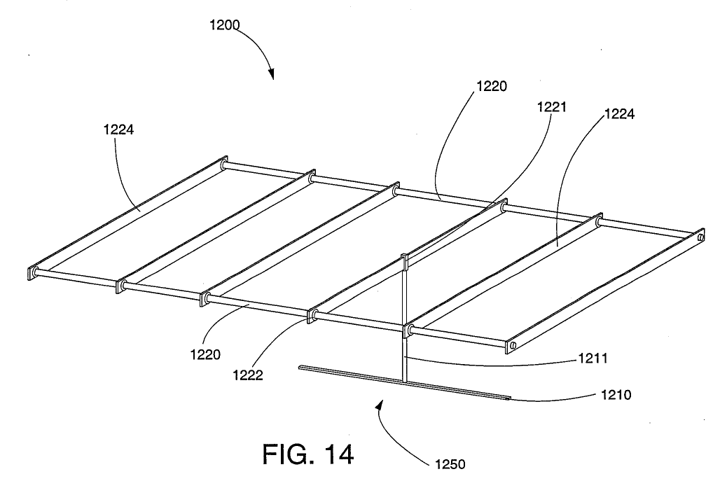

FIG. 14 illustrates yet another embodiment of another roller grill separating device 1200. The roller grill separating device 1200 comprises a support base member 1250, two crossover bars 1220, and a plurality of separator bars 1224, and o-rings 1222. The support base member 1250 comprises a frame portion 1221, a leg portion 1211, and a base portion 1210, to support the roller grill separating device.

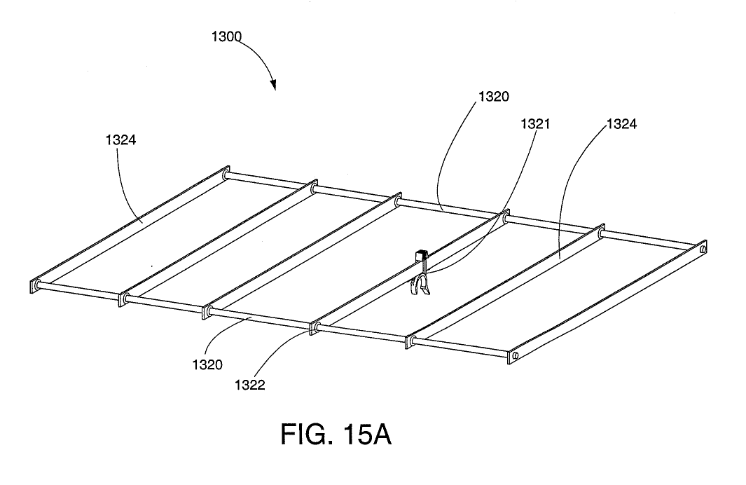

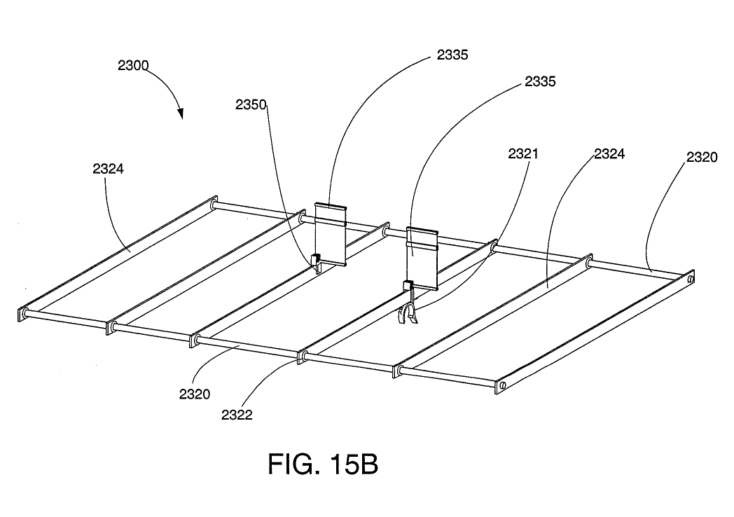

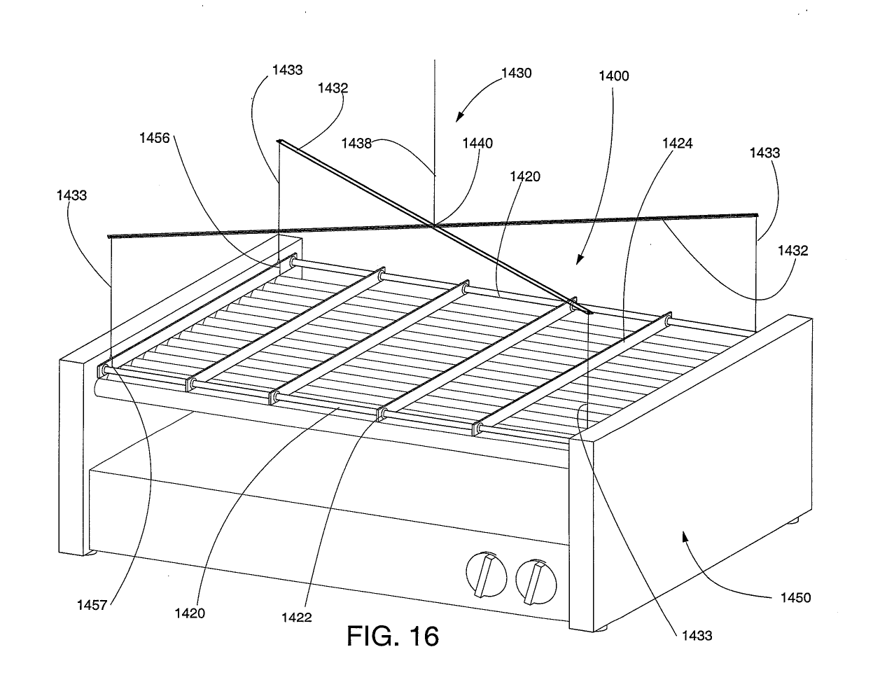

FIGS. 15A and 15B illustrate further embodiments of another roller grill separating device 1300 and 2300, respectively. The roller grill separating device 1300 comprises a clip 1321, two crossover bars 1320, and a plurality of separator bars 1324, and o-rings 1322. The clip 1321 is the same as the clip depicted in FIG. 5. The roller grill separating device 1300 can be mounted on a roller grill by clipping the clip 1321 on any roller of the grill.

In FIG. 15B, the same elements shown in FIG. 15A have been renumbered so that the elements are labeled by reference numerals that start with 23 instead of starting with 13. FIG. 15B shows a clip 2321 and another type of clip 2350. These clips 2321 and 2350 have a molded plastic sign holder 2335 disposed therein. The sign holder 2335 includes slides for allowing descriptions and marketing information to be included.

FIG. 16 illustrates yet another embodiment of another roller grill separating device 1400 disposed on a roller grill 1450. The roller grill separating device 1400 comprises an upper portion 1430, two crossover bars 1420, and a plurality of separator bars 1424, and o-rings 1422. The upper portion 1430 comprises two elongated member 1432, an upper attachment wire or thread 1438, and four lower attachment wires or threads 1433. The two elongated members 1432 meet in the middle 1440 and the upper attachment wire or thread 1438 is tied to the middle 1440. An upper end of each of the lower attachment wire or threads 1433 is tied to an end of the elongated portion 1432. A lower end of each of the lower attachment wire or threads 1433 is tied to ends of the separator bars 1424 as shown by a loop 1457 at a proximate side and a loop 1456 at a distant side. The roller grill separating device 1400 can be hung from the top of a grill cover or from the ceiling by attaching the top end of the upper attachment wire or thread 1438.

As discussed above, any suitable materials such as plastic and metal can be used to make the present invention, and methods of manufacturing are not particularly limited.

Although the embodiments described herein are directed to use of the present separating device in conjunction with a roller grill, the invention is in no way limited thereto. In fact, the present invention can be used in any application where it is useful to separate a certain type of products from another. Some of these other applications will be described below but the description is for exemplary purposes only, and numerous other applications can be envisioned.

In supermarkets, the present invention could be used to separate different types of produce and to indicate the name of the vegetable, the price per pound and the expiration dates next to the particular items.

According to the present invention, a user can seclude cooked products in one area so that they can add uncooked products in the other areas.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

What is claimed is:

1. A food separating device comprising:
a plurality of support members, each of said support members being disposed on respective opposite sides of said food separating device;
a pair of crossover bars, each of said crossover bars being disposed on opposite sides of said food separating device;
at least one separator bar being disposed around at least a portion of said crossover bars; and
wherein said crossover bars and support members form a rectangular shape.

2. The food separating device as defined in claim 1, wherein each of said support members comprises an upper section capable of being disposed on a side housing of a roller grill, a middle section capable of being disposed adjacent a side housing surface of the roller grill, and a lower section capable of extending outwardly so a recess is formed in said lower section and an end of said crossover bar is disposed in the recess.

3. The food separating device as defined in claim 2, wherein said plurality of support members comprise two members that are capable of being disposed on a housing of a cooking device.

4. The food separating device as defined in claim 1, wherein said plurality of support members comprise four members capable of supporting ends of said crossover bars.

5. The food separating device as defined in claim 4, wherein two of said plurality of support members have a height larger than the height of the other two of said support members.

6. The food separating device as defined in claim 1, wherein said at least one separator bar having an opening for receiving one of said crossover bars therein.

7. The food separating device as defined in claim 6, wherein the opening in said at least one separator bar for receiving one of said crossover bars therein completely surrounds one of said crossover bars.

8. The food separating device as defined in claim 6, wherein the opening in said at least one separator bar for receiving one of said crossover bars therein is a recess formed in a side of said at least one separator bar and said at least one separator bar can be disposed on one of said crossover bars.

9. The food separating device as defined in claim 8, wherein at least two recesses are formed adjacent opposite ends of said at least one separator bar and said at least two recesses are capable of being disposed on one of said crossover bars to support said at least one separator bar.

10. The food separating device as defined in claim 1, wherein said support members have a length substantially equal to a length of said at least one separator bar.

11. The food separating device as defined in claim 1, wherein said support members have a length less than a length of said separator bars.

12. The food separating device as defined in claim 1, further comprising at least one clip disposed on said at least one separator bar, said at least one clip being capable of receiving signage.

13. The food separating device as defined in claim 12, further comprising a sign member; wherein said at least one clip includes at least two clips and said at least one separator bar includes at least two separator bars, each of said clips being disposed on top of a different one of said separator bars, said at least two clips being capable of receiving and supporting said sign member.

14. A food separating device as defined in claim 1, wherein said at least one separator bar being adjustable in length to form a different sized food separating device.

15. The food separating device as defined in claim 1, further comprising a magnetic member attached to each of said support members.

16. A roller grill separating device comprising:
a pair of crossover bars, each of said crossover bars being disposed at opposite ends of the device;
at least one separator bar having an opening at each end, said at least one separator bar being disposed at right angles to said crossover bars; and
a plurality of support members, each of said support members being disposed at both sides of the device,
wherein said crossover bars and support members form a rectangular shape,
wherein said crossover bars extend through the opening of said at least one separator bar, and
wherein each of said support members comprises an upper section being disposed over a housing of a roller grill, a middle section being disposed adjacent to a side of the housing of the roller grill, and a lower section extending outwardly so a recess is formed for receiving an end of said crossover bar.
